(19) United States
(12) Patent Application Publication
(10) Pub. No.: US 2016/0215756 A1
(43) Pub. Date: Jul. 28, 2016

(54) WIND TURBINE GENERATOR COMPATIBLE WITH HIGH AND LOW WIND SPEEDS

(71) Applicant: Shenzhen Bangzhong Wind Power Generation Technology Co., Ltd., Shenzhen, Guangdong (CN)

(72) Inventors: Zhiwei Geng, Shenzhen, Guangdong (CN); Bangzhong Geng, Shenzhen, Guangdong (CN)

(21) Appl. No.: 14/770,465

(22) PCT Filed: May 30, 2014
(86) PCT No.: PCT/CN2014/078958

§ 371 Date: Aug. 26, 2015

(30) Foreign Application Priority Data
May 6, 2014 (CN) 201410189598.3

(51) Int. Cl. F03D 1/06; F03D 7/02; F03D 9/00

(52) U.S. Cl. CPC F03D 1/0633; F03D 9/002; F03D 7/02; F03D 1/0675; F03D 7/028

(57) ABSTRACT

Disclosed is a wind turbine generator compatible with high and low wind speeds, which includes: a fan blade assembly, which comprises a rotation shaft and at least one fan blade connected with the rotation shaft, the fan blade comprising a curved plate, a cover plate which is fixedly connected with an edge of the curved plate so as to form an air inlet together with the curved plate and a connecting member provided for installation of the fan blade; a speed increaser, which has a rotation shaft connected with the fan blade assembly; a wind-driven generator, which is driven to generate electricity by the speed increaser; and a mounting rack, which is provided to fix the speed increaser and the wind-driven generator. The present invention is applicable to a wide range of wind speed and has high-usage of wind energy, simple structure and long life.

### FIELD OF THE INVENTION

The present invention relates to wind power technology, and more particularly to a wind turbine generator compatible with high and low wind speeds which can generate electricity both at low wind speed and at high wind speed.

### BACKGROUND OF THE INVENTION

In nature, most of the energy is limited and is not recycled. More and more energy was consumed with the constant development of natural energy and due to the ever increasing population. In recent years, the global warmer weather is melting glaciers and the environment worsens day by day. The people of the whole world pay more attention on energy conservation and emissions reduction and it is urgent to make a sustainable development strategy including developing new energy and protecting the ecological environment. Especially in many developing nations, as the backwardness of science and technology, the development of economy depends mostly on the consumption of abundant natural resources, thereby causing the environment even worsen.

In order to solve the existing environmental problems, developing new energy is a task which brooks no delay. The new energy refers to any energy except traditional energy. At present, there are four kinds of new energy have advanced enough and have been used massively, which includes solar power, wind power, marsh gas and fuel cell. Under the circumstance of lack of energy, new energy power generation will become mainstream technology in the field of power generation.

The application of wind power receives more and more attention, especially in northwest region where there has abundant wind energy resource and is lack of other resources, thus, wind-power development is a preferable solution to energy problems. Now, wind power generation is the primary means to utilize the wind, but only when the wind speed reaches a certain value within a certain range the wind turbine generator used for wind power generation can be started up. As we known, both of the wind speed and the wind direction are greatly influenced by the climate and the region characteristic, thus both of them are not constant. The existing horizontal axis type wind-generator is only usable when the wind speed reaches 5-12 m/s, thus all of the wind power, the speed of which is without the above range, will be wasted. At present, the existing wind turbine generator generally has following defects:

1. The existing wind-driven generator is very hard to be started up when the wind speed is low, thereby huge amounts of energy is wasted and the application range of the wind-driven generator is limited.

2. If the wind speed exceeds a certain value, the existing wind-driven generator needs to bear enormous loads so that the fan blades thereof will be damaged due to the restrictions of its own structure. As a result, the wind resources with high wind speed will be wasted and the life of the wind-driven generator will be reduced and the maintenance cost will be relatively high.

There are two ways to solve the above problems as follows: one is to brake in electronic format by means of short circuit and the other one is to brake by means of friction plate. However, both of the two above methods have defects. The former will produce very high impulse current instantaneously, thus the wind-driven generator is easy to be damaged. The latter will cause the friction plate to be worn and then the fan blades will be destroyed easily when facing heavy wind. In order to solve the above problem, it needs to change the friction plate frequently which will bring higher maintenance cost and lower economic benefit.

3. At present, the common power generator generally brakes or stops to run directly when facing heavy wind, as a result, it wastes huge amounts of energy.

At present, in order to solve the above technical problems, numerous attempts have been made. It is proposed that a power generation which can work at high wind speed and a power generation which can work at low wind speed could be combined to be a power generation assembly so as to solve the technical problem that the wind-driven generator cannot work both at high wind speed and low wind speed. For example, Chinese patent application No. 201210593121.2 discloses a wind turbine generator compatible with high and low wind speeds, which is composed of a high-speed wind generating set, a low-speed multiple-pin wind wheel and a transmission shaft. Wherein the wind turbine generator is provided with high-speed wind wheel and low-speed multiple-pin wind wheel so that the wind turbine generator has function of generating electricity at high wind speed and at low wind speed. The low-speed multiple-pin wind wheel is mounted on an appropriate location of the main shaft of the high-speed wind generating set so as to provide rotary force to the high-speed wind generating set at low wind speed, thereby making the high-speed wind generating set keep running normally. However, the wind turbine generator has just improved the scope of application of the wind turbine generator within limits, but it is still easy to be damaged when the wind speed is high and it is still hard to be started up when the wind speed is low.

### SUMMARY OF THE INVENTION

The technical problem to be solved is to overcome the above defects of the prior art by providing a wind turbine generator compatible with high and low wind speeds, which can achieve efficient use of wind energy both at low wind speed and at high wind speed, by means of the improvement of the structure of the fan blades thereof.

To solve the above problem, there are provided following technical solutions:

A wind turbine generator compatible with high and low wind speeds, includes: a fan blade assembly, which comprises a rotation shaft and at least one fan blade connected with the rotation shaft, the fan blade comprising a curved plate which is provided with a concave structure formed on a central zone thereof, a cover plate which is fixedly connected with an edge of the curved plate so as to form an air inlet together with the curved plate and a connecting member provided for installation of the fan blade, the curved plate having a resistance portion formed on a side thereof and having a plurality of spray holes formed on the same side thereof; a speed increaser, which has a rotation shaft connected with the fan blade assembly; a wind-driven generator, which is driven to generate electricity by the speed increaser; and a mounting rack, which is provided to fix the speed increaser and the wind-driven generator.

Preferably, the fan blade assembly comprises 2 to 6 fan blades.

Preferably, the mounting rack comprises a mounting platform which is provided with seats for installation of the wind-driven generator and the mounting rack, a connecting part fixed on a baseplate of the mounting platform and a positioning pillar rotatably connected with the connecting part.

Preferably, the speed increaser has an elevation angle adjusting device for adjusting an elevation angle in a range of 15 degree to 88 degree.

Preferably, each fan blade of the fan blade assembly has a fan blade angle of 15 degree to 60 degree.

Preferably, the speed increaser is capable of making the speed change ratio reach to 2-16 times.

Preferably, the fan blade further comprises a central shaft fixed on the cover plate and a supporting member which has an end fixed on the central shaft and another end fixed on the curved plate.

Preferably, the resistance portion is a cambered surface.

Preferably, the central shaft is a conical rod or tube.

Preferably, both of the curved plate and the cover plate are a plate-type structure which is formed by fiberglass layers and epoxy resin layers overlaid with each other one by one.

Compared with the prior art, the present invention has following beneficial effects: the wind turbine generator compatible with high and low wind speeds of the present invention can start up and generate electricity quickly when the wind speed is low, and it can realize balance control when the wind speed is high, thereby achieving high-usage of wind energy. It has simple structure, long life, wide range of application and it could be widely used in a large area.

### BRIEF DESCRIPTION OF THE DRAWINGS

FIG. 1 is a side view of the wind turbine generator compatible with high and low wind speeds according to an embodiment of the present invention;

FIG. 2 illustrates varying state of the wind turbine generator compatible with high and low wind speeds according to an embodiment of the present invention;

FIG. 3 is perspective view of the fan blade of the wind turbine generator compatible with high and low wind speeds according to an embodiment of the present invention;

FIG. 4 is a front view of the fan blade of the wind turbine generator compatible with high and low wind speeds according to an embodiment of the present invention;

FIG. 5 is a side view of the fan blade of the wind turbine generator compatible with high and low wind speeds according to an embodiment of the present invention;

FIG. 6 is a top view of the fan blade of the wind turbine generator compatible with high and low wind speeds according to an embodiment of the present invention;

FIG. 7 is a cross sectional view of the fan blade of the wind turbine generator compatible with high and low wind speeds according to an embodiment of the present invention;

FIG. 8 illustrates a fan blade angle of the wind turbine generator compatible with high and low wind speeds according to an embodiment of the present invention;

### DESCRIPTION OF THE REFERENCE NUMBER IN THE FIGURES

fan blade assembly 1; fan blade 11; curved plate 110; curved plate body 111; resistance portion 112; cover plate 12; air inlet 121; central shaft 13; supporting member 14; connecting member 15; connecting rod 151; mounting plate 152; mounting hole 1521; spray hole 16; plane 17; speed increaser 2; rotation shaft 21; mounting part 22; wind-driven generator 3; mounting rack 4; mounting platform 41; supporting part 42; connecting part 43; positioning pillar 44.

### DETAILED DESCRIPTION OF ILLUSTRATED EMBODIMENTS

For understanding the technical content of the present invention more sufficiently, some embodiments of the present invention will be described as follows, by way of example only, with reference to the accompanying drawings.

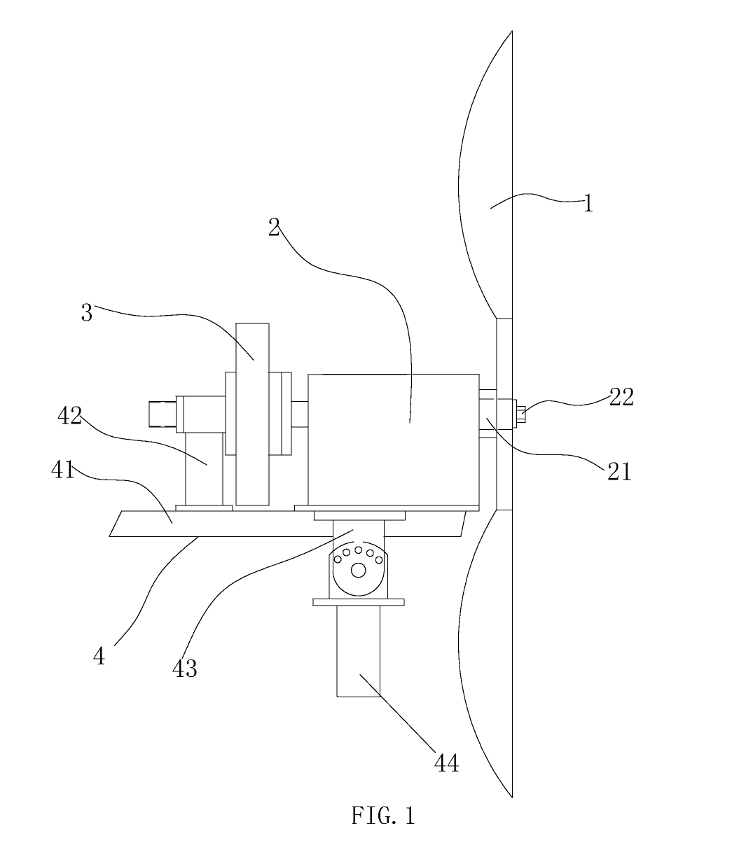

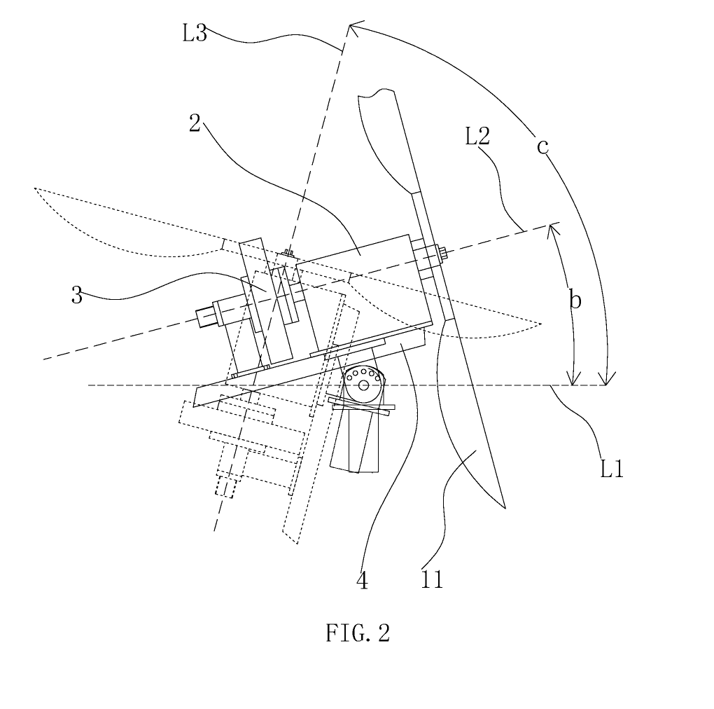

Referring to FIG. 1 and FIG. 2, the wind turbine generator compatible with high and low wind speeds includes a fan blade assembly 1, a speed increaser 2, wind-driven generator 3 and a mounting rack 4. The fan blade assembly 1 includes at least one fan blade. The speed increaser 2 has a rotation shaft connecting with the fan blade assembly 1. The wind-driven generator 3 has a rotation shaft connecting with the speed increaser 2. The speed increaser 2 and the wind-driven generator 3 are fixed on the mounting rack 4.

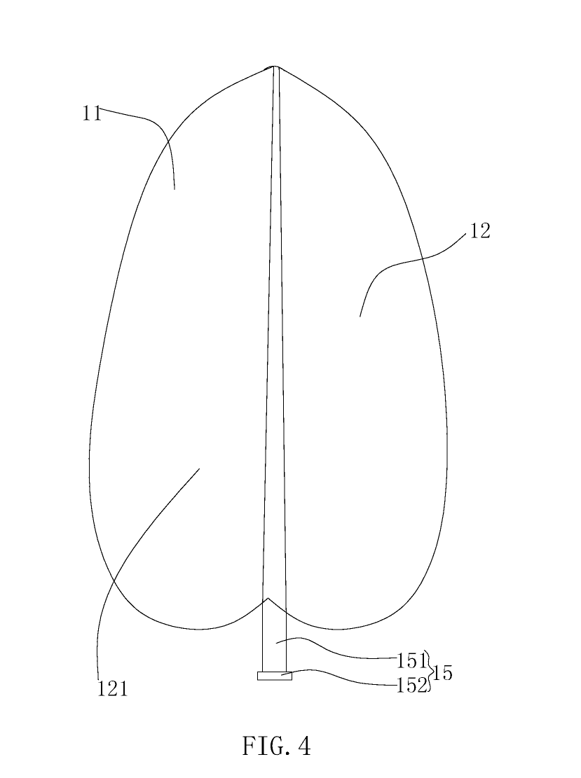

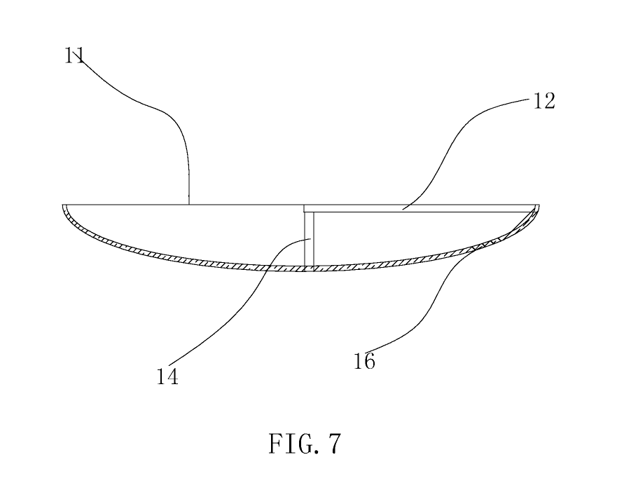

Referring to FIG. 1 to FIG. 7, the fan blade assembly 1 includes at least one fan blade 11. Preferably, the fan blade assembly 1 includes 2 to 5 fan blades.

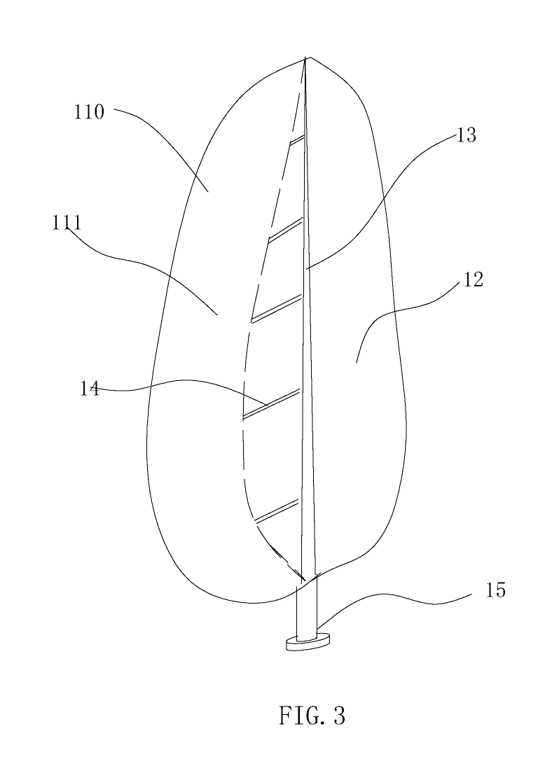

Referring to FIG. 3 to FIG. 5, the fan blade 11 includes a curved plate 110 which is provided with a concave structure formed on a central zone thereof, a cover plate 12 which partly covers the concave structure of the curved plate 110 along the edge of the curved plate, a central shaft 13 fixed on the cover plate 110 several supporting members 14 which has an end fixed on the central shaft 13 and another end fixed on the curved plate 110, a connecting member 15 connecting to one end of the central shaft 13 and a plurality of spray holes 16 provided on the curved plate 110 which is covered by the the cover plate 12.

Referring to FIG. 3 to FIG. 5, the curved plate 110 includes a curved plate body 111 and a resistance portion 112. The curved plate body 111 has a larger dimension in longitudinal direction than that in transverse direction (it should be noted that the longitudinal direction refers to the direction of the length and the transverse direction refers to the direction of width) and it is symmetrical about its longitudinal center line. The resistance portion 112 is a cambered surface and is located on right side of the curved plate 110. The spray holes 16 are located around or on the resistance portion 112. In this embodiment, the curved plate 111 is a sail shaped structure.

The curved plate body 111 is made of some materials having good performance of anti-solarization, anti-aging and high tenacity. In this embodiment, the curved plate body 111 is formed by fiberglass layers and epoxy resin layers overlaid with each other one by one. Preferably, the curved plate body 111 is made of carbon fibers.

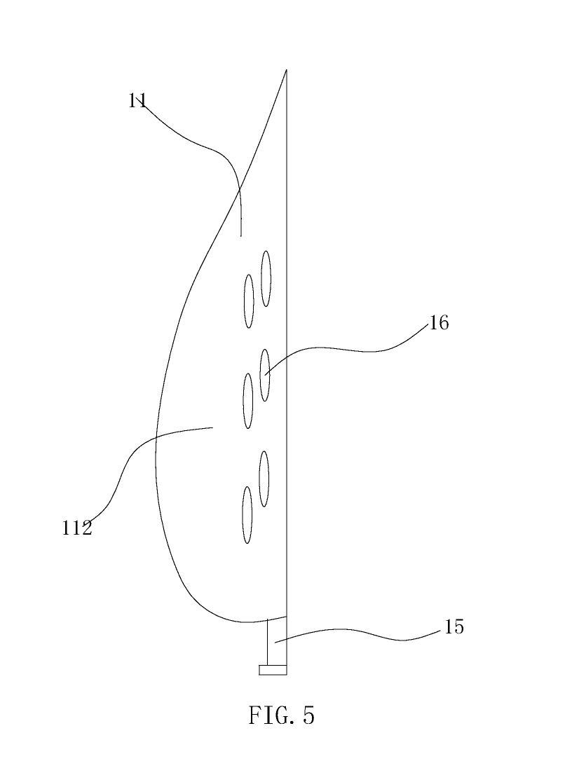

Referring to FIG. 3 and FIG. 5, the curved edge of the cover plate 12 has the same shape as that of the edge of the curved plate 110. The curved edge of the cover plate 12 is connected with the edge of the curved plate 110 fixedly and hermetically. The cover plate 12 includes a straight edge which is parallel to the longitudinal center line of the curved plate 110. The cover plate 12 and the curved plate 110 provide a cavity together and the cover plate 12 partly covers the cavity of the curved plate 110. There is an air inlet 121 formed between the cover plate 12 and the curved plate 110 for allowing natural wind to enter into the fan blade and then drive the fan blade to rotate.

The cover plate 12 is made of some materials having good performance of anti-solarization, anti-aging and high tenacity. In this embodiment, the cover plate 12 is formed by fiberglass layers and epoxy resin layers overlaid with each other one by one. Preferably, the cover plate 12 is made of carbon fibers.

Referring to FIG. 1, the central shaft 13 is a rod or tube made of materials with high strength and high tenacity. The central shaft 13 is a conical structure which has a radius getting large from an upper end to a lower end thereof. The central shaft 13 is fixed on the cover plate 12 so as to enhance the structural strength of the fan blade. The central shaft 13 is designed to be conical structure so as to reduce the centrifugal force when the fan blade is rotating at high speed and enhance tension intensity of the central shaft 13. The central shaft 13 is parallel to the longitudinal symmetry line of the curved plate 110.

Referring to FIG. 3, there are multiple supporting members 14, each of which has one end fixed on the central shaft 13 and another end fixed on the curved plate body 111. The supporting members 14 could be supporting rods and also could be supporting plates 14. The supporting members 14 are evenly arranged between the curved plate body 111 and the central shaft 13. The supporting members 14 are provided to enhance the structural strength of the fan blade and then enhance the wind-resistant performance thereof, and increase the force bearing area to rotate the fan blade when the wind speed is low.

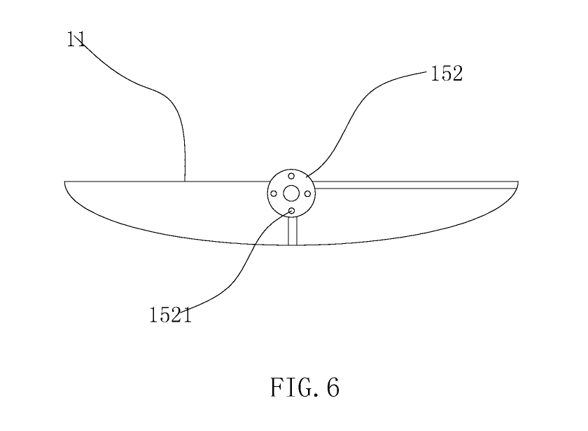

Referring to FIG. 3, FIG. 5 and FIG. 6, the connecting member 15 includes a connecting rod 151 and a mounting plate 152. The connecting rod 151 has one end fixedly connecting with the end of the central shaft 13 and another end fixedly connecting with the mounting plate 152. There are multiple mounting hole 1521 formed on the mounting plate 152 symmetrically. The connecting member 15 is used to install the curved plate 110 onto a center of rotation of a wind turbine generator.

Referring to FIG. 5, the spray holes 16 formed on the resistance portion 112 are elliptic or rounded through-holes. In this embodiment, multiple sets of spray holes 16 are evenly proved on resistance portion 112 and each set is consists of two spray holes 16.

Referring to FIG. 1 and FIG. 2, there is a mounting part 22 connecting with the rotation shaft 21 of the speed increaser 2. The mounting part 22 has multiple seats (not shown) for fixedly connecting with the mounting plate 152 of fan blade. The fan blade assembly 1 includes at least one fan blade 11 which is connected with the speed increaser 2. Under the action of wind power, the fan blade 11 will start to rotate and in turn drive the speed increaser 2 to rotate. When the speed increaser 2 is started, the power will be passed to the wind-driven generator 3 via a power take-off shaft thereof. In this embodiment, the wind speed could be improved 2 to 16 times by the speed increaser 2 and then the power is passed to the wind-driven generator 3.

Referring to FIG. 1 and FIG. 2, the mounting rack 4 includes a mounting platform 41 which is provided with seats for the installation of the wind-driven generator and the mounting rack, a supporting part 42 for supporting the rotation shaft on a side of the wind-driven generator 3, a connecting part 43 fixed on a baseplate of the mounting platform and a positioning pillar 44 rotatably connected with the connecting part 43. The positioning pillar 44 is used to make the mounting rack 4 be fixed on the ground or other positions suitable for wind power generation. The angle between the plane of the fan blade of the fan blade assembly 1 and the horizontal plane, which is called elevation angle, could be adjusted by adjusting the relative angle between the connecting part 43 and the positioning pillar 44. After being adjusted to be a suitable angle, such an angle could be fixed.

Referring to FIG. 2, the dashed part shows a relative position of the wind turbine generator compatible with high and low wind speeds after being adjusted. The horizontal line is indicated by L1, the shaft axis of the rotation shaft connecting the speed increaser 2 and the wind-driven generator 3 is indicated by L2 and L3 (after being adjusted), and the minimum angle between L1 and L2 is indicated by b and a maximum rotation angle between L1 and L3 is indicated by c. In this embodiment, the minimum angle b is 5 degree, and the maximum rotation angle c is 88 degree.

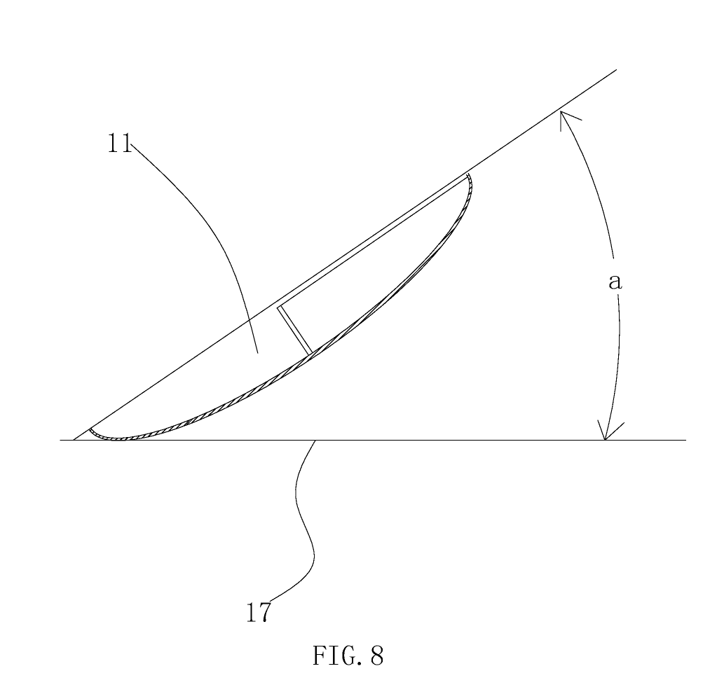

Referring to FIG. 8, in this embodiment, a fan blade assembly with four fan blades is taken as an example to illustrate the present invention. The lowest point of the concave structure of the curved plate 110 is taken as base point and a plane 17 is defined by the lowest points of the concave structures of the four fan blades. Under normal conditions, the four fan blades 11 are in the same plane and the angle a between the cover plate 12 and the plane 17 defined by the four fan blades 11 is 0 degree. In order to make better use of the wind power at low wind speed, the angle a between each fan blade 11 and the plane 17, called as a fan blade angle, has a range of 0 degree to 60 degree.

In other embodiments, the curved plate 110 could be peach shaped or banana leaf shaped, and it also could be semi-cylinder shaped or semi-cone shaped. Preferably, the curved plate 110 is a sail shaped structure with arc-shaped edge and the width of upper part thereof is smaller than that of the lower part thereof.

The above wind turbine generator compatible with high and low wind speeds, which includes four fan blades, is taken as an example to illustrate the operating principle of the present invention as follows: in practical application, the elevation angle of the fan blade assembly and the fan blade angel could be adjusted to be a suitable value according to actual geographical conditions and climate status. When the natural wind blows towards the fan blade assembly, the wind power applied on the fan blades located in the top-left, bottom-left and top-right regions is driving force for driving the fan blade assembly to rotate. Because each fan blade has its own cavity and has resistance portion and spray holes formed on a side thereof, the wind forces will totally be absorbed by the fan blades with cavity and then be transformed into rotary power when the wind speed is relatively low, generally under 0.8 m/s, and when the wind speed is relatively high, generally exceeding 12 m/s, the wind power is bigger but the wind power which the fan blade can bear on the front side is limited, and the lower right corner of the fan blade will suffer a resistance force every moment during the fan blade assembly rotating. The resistance portion of the curved plate is an acting surface of the resistance force and the spray holes formed on the resistance portion can play a role in shunting of wind power. Through relevant experiments, it is proved that if the fan blade assembly is fixed with a suitable elevation angle and suitable fan blade angel, the fan blades can automatically achieve a balance between the driving force and resistance force of wind power due to its own structure when the wind speed is too high and then keep at a certain rotation speed, at this time, the rotation speed of the fan blade assembly will not increase as the natural wind power increases, thereby avoiding braking and short circuit needed by common wind turbine generator, enhancing the ability of bearing wind force of the fan blades, increasing the life of the fan blades and ensuring the wind turbine generator works at full capacity so as to utilize wind energy resources efficiently when the wind speed is high.

Above descriptions of embodiments are provided for further illustrating the technical content of the present invention, so as to facilitate understanding and it should be understood that the invention is not to be limited to the disclosed embodiments. Any technique extension and recreation according to the present invention should be included within the scope of protection of the invention.

What is claimed is:

1. A wind turbine generator compatible with high and low wind speeds, comprising:
a fan blade assembly, which comprises a rotation shaft and at least one fan blade connected with the rotation shaft, the fan blade comprising a curved plate which is provided with a concave structure formed on a central zone thereof, a cover plate which is fixedly connected with an edge of the curved plate so as to form an air inlet together with the curved plate and a connecting member provided for installation of the fan blade, the curved plate having a resistance portion formed on a side thereof and having a plurality of spray holes formed on the same side thereof;
a speed increaser, which has a rotation shaft connected with the fan blade assembly;
a wind-driven generator, which is driven to generate electricity by the speed increaser; and
a mounting rack, which is provided to fix the speed increaser and the wind-driven generator.

2. The wind turbine generator compatible with high and low wind speeds according to claim 1, wherein the fan blade assembly comprises 2 to 6 fan blades.

3. The wind turbine generator compatible with high and low wind speeds according to claim 1, wherein the mounting rack comprises a mounting platform which is provided with seats for installation of the wind-driven generator and the mounting rack, a connecting part fixed on a baseplate of the mounting platform and a positioning pillar rotatably connected with the connecting part.

4. The wind turbine generator compatible with high and low wind speeds according to claim 3, wherein the speed increaser has an elevation angle adjusting device for adjusting an elevation angle in a range of 15 degree to 88 degree.

5. The wind turbine generator compatible with high and low wind speeds according to claim 1, wherein each fan blade of the fan blade assembly has a fan blade angle of 15 degree to 60 degree.

6. The wind turbine generator compatible with high and low wind speeds according to claim 1, wherein the speed increaser is capable of making the speed change ratio reach to 2-16 times.

7. The wind turbine generator compatible with high and low wind speeds according to claim 1, wherein the fan blade further comprises a central shaft fixed on the cover plate and a supporting member which has an end fixed on the central shaft and another end fixed on the curved plate.

8. The wind turbine generator compatible with high and low wind speeds according to claim 1, wherein the resistance portion is a cambered surface.

9. The wind turbine generator compatible with high and low wind speeds according to of claim 7, wherein the central shaft is a conical rod or tube.

10. The wind turbine generator compatible with high and low wind speeds according to of claim 1, wherein both of the curved plate and the cover plate are a plate-type structure which is formed by fiberglass layers and epoxy resin layers overlaid with each other one by one.
